(19) United States
(12) Patent Application Publication
(10) Pub. No.: US 2024/0373519 A1
(43) Pub. Date: Nov. 7, 2024

(54) Induction Heating Device, Method for Manufacturing Electrode Assembly Including the Same, and Apparatus for Manufacturing Electrode Assembly Including the Same

(71) Applicant: LG Energy Solution, Ltd., Seoul (KR)

(72) Inventors: Jong Seok Kim, Daejeon (KR); Yong Nam Kim, Daejeon (KR)

(73) Assignee: LG Energy Solution, Ltd., Seoul (KR)

(21) Appl. No.: 18/644,565

(22) Filed: Apr. 24, 2024

(30) Foreign Application Priority Data
May 4, 2023 (KR) 10-2023-0058195

(51) Int. Cl. H05B 6/36; H01M 4/04

(52) U.S. Cl. CPC H05B 6/36; H01M 4/043; H01M 4/0471

(57) ABSTRACT

An induction heating device, a method for manufacturing an electrode assembly including the same, and an apparatus for manufacturing an electrode assembly including the same are all provided. The induction heating device includes an induction heating plate with an induction heating coil included therein. The inducting heating coil includes a first part defining a meandering serpentine pattern along a longitudinal direction of the induction heating plate, and a second part configured to cross the first part of the induction heating coil when projected on a plane from a top view. The second part includes segments extending in the longitudinal direction along opposing sides of the first part in the width direction of the induction heating plate.

### CROSS-REFERENCE TO RELATED APPLICATIONS

This application claims priority to and the benefit of Korean Patent Application No. 10-2023-0058195 filed in the Korean Intellectual Property Office on May 4, 2023, the entire contents of which are incorporated herein by reference.

### TECHNICAL FIELD

The present invention relates to an induction heating device, a method for manufacturing an electrode assembly including the same, and an apparatus for manufacturing an electrode assembly including the same.

### BACKGROUND ART

Unlike a primary battery, a secondary battery can be recharged and may be formed in a small size or with a large capacity. Accordingly, a lot of research and development on secondary batteries are currently in progress. Along with the technology development and the increase in demand for mobile devices, the demand for secondary batteries as an energy source is sharply increasing.

Secondary batteries are classified into coin type batteries, cylindrical type batteries, prismatic type batteries, and pouch type batteries, according to a shape of a battery case. In a secondary battery, an electrode assembly mounted inside a battery case is a chargeable and dischargeable power generating device having a structure in which an electrode and a separator are stacked.

The electrode assembly may be approximately classified into (1) a jelly-roll type electrode assembly, in which a separator is interposed between a positive electrode and a negative electrode, each of which is provided in the form of a sheet coated with an active material, and then the positive electrode, the separator, and the negative electrode are wound, (2) a stack-type electrode assembly, in which a plurality of positive and negative electrodes with a separator therebetween are sequentially stacked, and (3) a stack and folding-type electrode assembly, in which stack-type unit cells are wound with a separation film having a long length.

In the stack and folding-type electrode assembly, the separator is folded and stacked in a zigzag form, and the positive electrode or the negative electrode is inserted between folds of the separator. As a result, an electrode assembly in which the positive electrode, the separator, and the negative electrode are stacked is manufactured.

In the above process, in order to bond the electrodes and the separator to one another, heat and pressure are applied to the stack in which the positive electrode, the separator, and the negative electrode are stacked. However, it can take a long time and a lot of energy to bond the electrodes (positive electrode, negative electrode) and the separator in the stack by applying heat and pressure to the stack. Moreover, when applying heat and pressure to the stack, there can result a problem in that heat and pressure cannot be uniformly applied regardless of the stacked positions of the electrodes and separator due to differences in stacked positions (stacked heights) of the electrodes and separator in the stack. That is, there can occur a problem in that adhesive force between the separator and the electrodes is not constant. As a result, the performance of the electrode assembly may not be uniform.

In order to solve the above problem, a method of inductively heating a stack including an electrode and a separator has been considered. However, due to a shape of a coil used for induction heating, it is difficult to produce a desired level of temperature uniformity.

Accordingly, it is desirable to study the shape of the induction heating coil for improving temperature uniformity.

### SUMMARY OF THE INVENTION

The present invention has been made in an effort to provide an induction heating device for solving a problem caused by non-constant adhesive force, a method for manufacturing an electrode assembly including the same, and an apparatus for manufacturing an electrode assembly including the same.

An exemplary embodiment of the present invention provides an induction heating device including at least one induction heating plate and an induction heating coil built in the induction heating plate, in which the induction heating coil includes a first part of induction heating coil configured to form a meandering serpentine pattern, and a second part of the induction heating coil configured to cross the first part of the induction heating coil when seen in a plan view, e.g., when projected on a plane from a top view.

Another exemplary embodiment of the present invention provides a method of manufacturing an electrode assembly including a first electrode, a separator, and a second electrode, the method including: performing stacking by stacking a stack including the first electrode, the separator, and the second electrode on a stack table; performing induction heating by inductively heating the stack with the induction heating device described above; and heating and pressing the inductively heated stack.

Still another exemplary embodiment of the present invention provides an electrode assembly manufacturing apparatus for manufacturing an electrode assembly including a first electrode, a separator, and a second electrode, the electrode assembly manufacturing apparatus including: a stack table on which the first electrode, the separator, and the second electrode are stacked and thus a stack including the first electrode, the separator, and the second electrode is placed; a heating and pressing unit configured to heat and press the stack; and an induction heating unit configured to inductively heat the stack before heating and pressing the stack in the heating and pressing unit, in which the induction heating unit is the induction heating device described above.

The induction heating device according to the exemplary embodiment of the present application can evenly transfer heat in the process of manufacturing an electrode assembly, thereby reducing temperature non-uniformity. The induction heating device according to the exemplary embodiment of the present application has advantages in terms of process because it can be applied to electrode assemblies of various sizes.

The electrode assembly manufacturing method and the electrode assembly manufacturing apparatus according to the exemplary embodiments of the present application can shorten the time required to manufacture the electrode assembly.

Since the electrode assembly manufacturing method and the electrode assembly manufacturing apparatus according to the exemplary embodiments of the present application can easily adjust a temperature of the electrode to a specific temperature range to reduce a temperature deviation between the electrodes, it is possible to provide an electrode assembly with uniform performance.

The electrode assembly according to the exemplary embodiment of the present application has a small air permeability deviation of the separator depending on the position, and therefore, has the advantage of uniform performance.

Still another exemplary embodiment of the present invention is an induction heating device including an induction heating plate and an induction heating coil included in the induction heating plate. The induction heating coil may include a first part and a second part. The first part of the induction heating coil may define a meandering serpentine pattern that extends along a first direction of the induction heating plate while reciprocating in a second direction of the induction heating plate, the second direction being orthogonal to the first direction. The second part of the induction heating coil may be arranged to cross the first part of the induction heating coil when projected along a third direction orthogonal to both the first and second directions. The second part may include a first segment and a second segment each extending in the first direction along respective first and second sides of the first part of the induction heating coil, the first and second sides being opposed to one another in the second direction of the induction heating plate.

Further in the same exemplary embodiment, the induction heating plate may include a first induction heating plate on which an electrode assembly including a positive electrode, a negative electrode and a separator arranged between the positive electrode and the negative electrode may be configured to be placed. The induction heating plate may further include a second induction heating plate opposed to and facing the first induction heating plate. The first part of the induction heating coil may be disposed along a first plane and the second part of the induction heating coil may be disposed along a second plane different from the first plane, and the first and second parts may be connected to each other by a third part of the induction heating coil. The third part of the induction heating coil may extend along the third direction perpendicular to the first and second planes. The first part of the induction heating coil may be disposed along a first plane and the second part of the induction heating coil may be disposed along the first plane, and the second part may circumvent the first part so as not to be short-circuited with the first part of the induction heating coil. When projected along the third direction, the second part of the induction heating coil may be arranged to cross vertices defined on the first part of the induction heating coil.

Further in the same exemplary embodiment, the second part of the induction heating coil may be configured to surround an outer edge of the first part of the induction heating coil in the second direction when projected along the third direction. The first part of the induction heating coil and the second part of the induction heating coil may be arranged to define at least one closed curve when projected along the third direction. The induction heating plate may comprise a non-conductive material. The first direction may be a longitudinal direction of the induction heating plate while the second direction may be a width direction of the induction heating plate. The first part of the induction heating coil may be configured to form a semi-elliptical shape while reciprocating in the second direction of the induction heating plate, wherein the semi-elliptical shape may have a long radius in the second direction of the induction heating plate and a short radius in the first direction of the induction heating plate. The long radius may be between 50 mm and 80 mm. The short radius may be between 10 mm and 40 mm. The first part of the induction heating coil may include a plurality of the semi-elliptical shape arranged periodically along the first direction of the induction heating plate. The period may be between 10 mm and 30 mm. The second part of the induction heating coil may include a third segment extending transverse to the first and second segments at a terminal end of the second part.

Still another exemplary embodiment of the present invention is a method for manufacturing an electrode assembly including a first electrode, a separator, and a second electrode. The method may include stacking a stack including the first electrode, the separator, and the second electrode on a stack table, inductively heating the stack, and heating and pressing the inductively heated stack. The stack may be inductively heated with an induction heating plate including an induction heating coil. The induction heating coil may include a first part of the induction heating coil defining a meandering serpentine pattern that extends along a first direction of the induction heating plate. The induction heating coil may include a second part of the induction heating coil arranged to cross the first part of the induction heating coil when projected along a third direction orthogonal to both the first and second directions. The second part may include a first segment and a second segment each extending in the first direction along respective first and second sides of the first part of the induction heating coil, the first and second sides being opposed to one another in the second direction of the induction heating plate.

Still another exemplary embodiment of the present invention is an electrode assembly manufacturing apparatus for manufacturing an electrode assembly including a first electrode, a separator, and a second electrode. The electrode assembly manufacturing apparatus may include a stack table, a heating and pressing unit, and an induction heating unit. A stack including the first electrode, the separator, and the second electrode may be placed on the stack table. The heating and pressing unit may be configured to heat and press the stack. The induction heating device may be configured to inductively heat the stack before heating and pressing the stack in the heating and pressing unit. The induction heating unit may be the induction heating unit described in any of the exemplary embodiments described throughout the present disclosure. Still another exemplary embodiment of the present invention is an induction heating device including an induction heating plate and an induction heating coil included in the induction heating plate. The induction heating coil may include a first part and a second part. The first part may extend along a first direction while reciprocating in a second direction orthogonal to the first direction. The second part may be arranged to cross a vertex defined by the first part of the induction heating coil when projected along a third direction orthogonal to both the first and second directions. The second part of the induction heating coil may include a segment extending tangential to the vertex defined by the first part of the induction heating coil when projected along the third direction.

### BRIEF DESCRIPTION OF THE DRAWINGS

FIG. 1 is a schematic view illustratively showing an induction heating unit of the related art.

FIG. 2 is a view showing a transfer pattern of an electrode assembly manufactured using the induction heating unit of the related art.

FIGS. 3 and 4 are views illustratively showing an induction heating unit according to exemplary embodiments of the present invention.

FIG. 5 is a view showing a transfer pattern and a graph of adhesive force per location across the width of an electrode assembly manufactured using an induction heating unit according to an exemplary embodiment of the present invention.

FIG. 6 is a side elevation view illustratively showing an electrode assembly manufacturing apparatus according to an exemplary embodiment of the present invention.

FIG. 7 is a top plan view showing a concept of the electrode assembly manufacturing apparatus according to the exemplary embodiment of the present invention.

FIG. 8 is a cross-sectional side elevation view illustratively showing a general electrode assembly.

FIGS. 9 and 10 are views illustratively showing processes of applying an electrode assembly manufacturing method or manufacturing apparatus according to exemplary embodiments of the present invention.

Part (a) of FIG. 11 is a perspective view showing a first heating and pressing unit 50 according to an exemplary embodiment of the present invention.

Part (b) of FIG. 11 is a perspective view showing a second heating and pressing unit 60 according to an exemplary embodiment of the present invention.

### DETAILED DESCRIPTION

Hereinafter, exemplary embodiments of the present invention will be described in detail such that one skilled in the art to which the present invention belongs can readily implement the same. However, the present invention may be embodied in various different forms, and is not limited to the configurations described herein.

When one part “includes”, “comprises” or “has” one constituent element in the present specification, unless otherwise specifically described, this does not mean that another constitutional element is excluded, but rather means that another constitutional element may be further included.

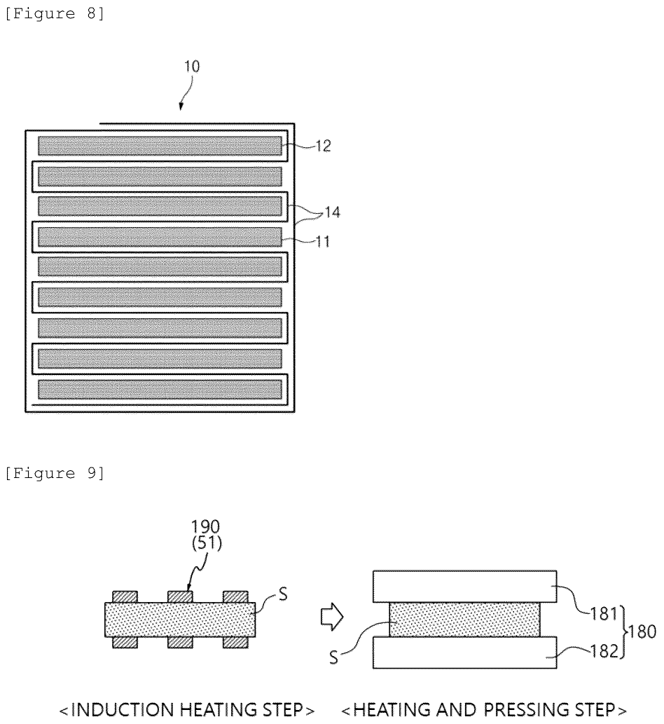

In an exemplary embodiment of the present invention, the electrode assembly may be stacked in such a form that the first electrode and the second electrode are alternately arranged between folds of the folded separator. That stacking form is referred to herein as zigzag stacking. In such form of stacking, the folded separator may refer to a separator that is stacked while overlapping in a zigzag form. More specifically, the separator is stacked in a zigzag form in which the separator is folded back and forth across the stacking axis between right and left sides of the stack. Further, such stacking includes the first electrode and the second electrode being alternately arranged between successive folds of the stacked separator. The stacking axis refers to a virtual axis parallel to a direction in which the first electrode, the separator, and the second electrode are stacked, and passing through a center of a stack in which the electrodes and the separator are stacked. Stated another way, the separator is provided in a single strip elongated along a longitudinal direction, and intermittent folds may be formed in the elongated strip along a direction perpendicular to the longitudinal direction, where each successive fold may be formed in an opposing direction to the previous fold. Alternating positive and negative electrodes may be positioned between each layer of the separator formed by the folds. For example, as shown in FIG. 8, a resulting stack of alternating positive and negative electrodes is formed, with each electrode being separated by a segment of the folded separator.

### <Induction Heating Device>

An exemplary embodiment of the present invention provides an induction heating device including an induction heating coil. An induction heating device according to an exemplary embodiment of the present invention may include an induction heating coil and an induction heating plate. The induction heating device according to embodiments of the present invention has a feature such that when the induction heating plate is seen from above, a first part of the induction heating coil has a meandering serpentine pattern, and a second part of the induction heating coil is arranged across the first part of the induction heating coil while being arranged on a plane different from the first part of the induction heating coil.

In an exemplary embodiment of the present invention, the second part of the induction heating coil includes a first segment and a second segment each extending in the first direction along respective first and second sides of the first part of the induction heating coil, the first and second sides being opposed to one another in the second direction of the induction heating plate. A “segment” is a divided part or section, and the “first segment” and “second segment” refer to the opposing parallel outer pieces of the U-shaped portion of the induction heating coil. Thus, each “segment” is referring to a section of the second part of the induction heating coil.

In an exemplary embodiment of the present invention, the first part of the induction heating coil and the second part of the induction heating coil may be arranged on planes different from each other and connected to each other by a third part of the induction heating coil. In this case, the first part of the induction heating coil and the second part of the induction heating coil may be integrally formed while being connected by the third part of the induction heating coil. The above feature makes it possible to optimize induction heating for the electrode assembly. Optimizing the induction heating means uniformly heating the electrode assembly and avoiding generation of a transfer pattern, i.e., a mark, on a certain part of an electrode assembly due to that part being heated relatively higher than other parts of the electrode assembly.

The induction heating device according to an exemplary embodiment of the present invention may be used for manufacture of an electrode assembly.

In an exemplary embodiment of the present invention, the induction heating plate may include a first induction heating plate on which an electrode assembly including a positive electrode, a negative electrode, and a separator arranged between the positive electrode and the negative electrode is placed; and a second induction heating plate aligned above the first induction heating plate. In this case, the first induction heating plate may be referred to as a lower heating plate, and the second induction heating plate may be referred to as an upper induction heating plate.

In the induction heating device according to an exemplary embodiment of the present invention, at least one of the first induction heating plate and the second induction heating plate may have the induction heating coil built therein. In addition, both the first induction heating plate and the second induction heating plate may each have the induction heating coil built therein.

In another embodiment of the present invention, the second part of the induction heating coil may be arranged on the same plane as the first part of the induction heating coil, but may be avoided or circumvented so as not to be short-circuited with the first part of the induction heating coil. That is, the second part may cross the first part when projecting the coil in a plane from a top view while avoiding physical contact with the first part on the same plane.

In an exemplary embodiment of the present invention, when portions of the second part of the induction heating coil are arranged on the same plane as the first part of the induction heating coil, the first part and the second part are continuous with each other. That is, the first part and the second part are connected.

In an exemplary embodiment of the present invention, a third part of the induction heating coil connecting the first part and the second part of the induction heating coil may be further included, and when seen in a plan view, the second part of the induction heating coil may cross the first part of the induction heating coil so as to overlap vertices defined by the first part of the induction heating coil. That is, the induction heating coil may have a two-layer structure of an upper layer and a lower layer. Here, the upper layer may correspond to a layer on which the first part of the induction heating coil is arranged, and the lower layer may correspond to a layer on which the second part of the induction heating coil is arranged.

An exemplary embodiment of the present invention provides an induction heating device including: a lower induction heating plate having one surface on which a heating target is placed; an upper induction heating plate having a surface facing the one surface of the lower induction heating plate; and an induction heating coil provided inside at least one of the lower induction heating plate and the upper induction heating plate, in which the induction heating coil has a two-layer structure of an upper layer and a lower layer, and the upper layer of the induction heating coil has a meandering serpentine pattern when seen in a direction of the one surface of the lower induction heating plate.

In an exemplary embodiment of the present invention, a third part of the induction heating coil may be arranged to extend in a height direction (or, e.g., a depth direction which is generally perpendicular to the plane(s) along which the first and second parts extend) of the induction heating plate so as to connect a first part of the induction heating coil and a second part of the induction heating coil arranged on planes different from each other. That is, the third part of the induction heating coil may extend in the height direction of the induction heating plate. The third part of the induction heating coil may also be arranged in a vertical direction, which is the height direction of the induction heating plate, or may also extend in an oblique direction.

The lower layer on which the second part of the induction heating coil is arranged may be level with the upper layer on which the first part of the induction heating coil is arranged, and the upper layer of the induction heating coil and the lower layer of the induction heating coil may have a spaced structure. That is, even in the case of a two-layer structure, the first part of the induction heating coil and the second part of the induction heating coil are arranged on different planes so as not to be short-circuited with each other.

In an exemplary embodiment of the present invention, a length of the third part may be 0 mm or longer. More specifically, the length may be 0 mm or longer and 40 mm or shorter, but the upper limit of the length may vary depending on a size of the induction heating plate. In this case, the length of the third part of 0 mm means that the first and second parts of the induction heating coil are arranged on the same plane, and the length of the third part longer than 0 mm means that the first part and the second part of the induction heating coil have a two-layer structure.

In an exemplary embodiment of the present invention, the first part of the induction heating coil and the second part of the induction heating coil may have a connected structure. In the case of a two-layer structure, a third part of the induction heating coil may be further included. For example, in the case of a two-layer structure, the first part of the induction heating coil has a meandering serpentine pattern from a start point to an end point of the first part. The induction heating coil then extends vertically from the end point of the first part of the induction heating coil in a direction towards the second part of the induction heating coil. Such vertically extending coil is the third part of the induction heating coil. The second part of the induction heating coil may be formed from an end point of the third part of the induction heating coil in a direction generally towards the start point of the first part of the induction heating coil. For example, the second part may extend in the same horizontal direction back toward the start point of the first part while remaining on a different, vertically spaced, parallel plane than the first part.

A shape of the second part of the induction heating coil is not particularly limited as long as it can cross the first part of the induction heating coil so as to overlap vertices defined by the first part of the induction heating coil. However, in the case of a two-layer structure, the second part may have a linear shape to reduce the process cost.

In addition, if the induction heating coil does not have a two-layer structure, the third part of the induction heating coil is not necessary. Further, a shape of the second part of the induction heating coil is not particularly limited as long as it is not short-circuited with the first part of the induction heating coil, and can cross the first part of the induction heating coil so as to overlap vertices defined by the first part of the induction heating coil, when seen in a plan view. However, the second part of the induction heating coil may have more linear portions to reduce the process cost.

The second part of the induction heating coil is arranged to cross the first part of the induction heating coil, but such crossing does not necessarily mean overlapping the first part of the induction heating coil when seen in a plan view. That is, when seen in a plan view, the second part of the induction heating coil may cross to overlap the first part of the induction heating coil, but may also cross to surround a periphery of the first part of the induction heating coil. That is, they may not overlap when seen in a plan view.

In an exemplary embodiment of the present invention, when seen in a plan view, the second part of the induction heating coil may surround an edge of the first part of the induction heating coil.

In an exemplary embodiment of the present invention, the first part of the induction heating coil and the second part of the induction heating coil may form at least one closed curve when seen in a plan view.

In an exemplary embodiment of the present invention, the at least one induction heating plate may include a non-conductive material. That is, in an exemplary embodiment of the present invention, at least one of the first induction heating plate and the second induction heating plate may include a non-conductive material.

The induction heating plate may include an alternating current generator for providing alternating current to the induction heating coil and may serve to protect the induction heating coil. The use of a non-conductive material as a material of the induction heating plate is to prevent an induced current by the induction heating coil from being generated also in the induction heating plate.

The induction heating plate may be a mold made of a non-conductive material. The non-conductive material may be epoxy, but is not limited thereto.

The induction heating coil and the induction heating plate may constitute one set.

The induction heating unit may include an alternating current generator, but is not limited thereto, and any means capable of generating an electromagnetic induction phenomenon for the induction heating coil may be applied.

In an exemplary embodiment of the present invention, the first part of the induction heating coil may form a serpentine pattern by proceeding in a longitudinal direction of the induction heating plate while reciprocating in a width direction of the induction heating plate.

In other words, the first part of the induction heating coil may have a meandering serpentine pattern that is built in the induction heating plate and proceeds in the longitudinal direction of the induction heating plate while reciprocating in a zigzag form in the width direction of the induction heating plate. The meandering serpentine pattern may be defined by a plurality of alternating semi-elliptical shapes each having a long radius (along the major axis) in a direction perpendicular to a central axis, i.e., the width direction of the heating plate, and having a short radius (along the minor axis) along a direction parallel to the central axis, i.e., the longitudinal direction of the heating plate. The central axis refers to a straight line passing through a center of the serpentine pattern along a direction in which the meandering serpentine pattern proceeds.

In an exemplary embodiment of the present invention, the first part of the induction heating coil forms a semi-elliptical shape while reciprocating in the width direction of the induction heating plate, where the semi-elliptical shape has a long radius in the width direction of the induction heating plate and a short radius in the longitudinal direction of the induction heating plate. The long radius may be between about 50 mm and about 80 mm, and the short radius may be between about 10 mm and about 40 mm.

In an exemplary embodiment of the present invention, the semi-elliptical shape may be periodically arranged along the central axis. In addition, in an exemplary embodiment of the present invention, a period of the coil may be between about 10 mm and about 30 mm, preferably between about 10 mm and about 25 mm, and more preferably between about 10 mm and about 25 mm.

When the above conditions are satisfied, the efficiency of induction heating can be further enhanced.

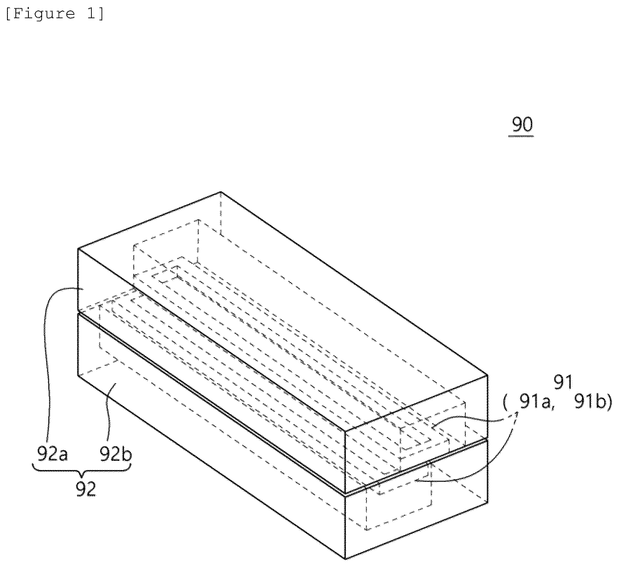

FIG. 1 illustratively shows an induction heating device of the related art. Referring to FIG. 1, an induction heating device 90 may include an induction heating coil 91 and an induction heating plate 92. More specifically, induction heating coils 91a and 91b may be built into induction heating plates 92a and 92b. The induction heating device 90 of the related art may include a U-shaped induction heating coil 91. The induction heating coils 91a and 91b may face each other. The specific arrangement of the induction heating coil 191 may be as shown in FIG. 1, but is not limited thereto. When alternating current is applied to the induction heating coil 191, induced current can be generated in the metallic electrodes in the stack, so the electrodes are heated by the induced current.

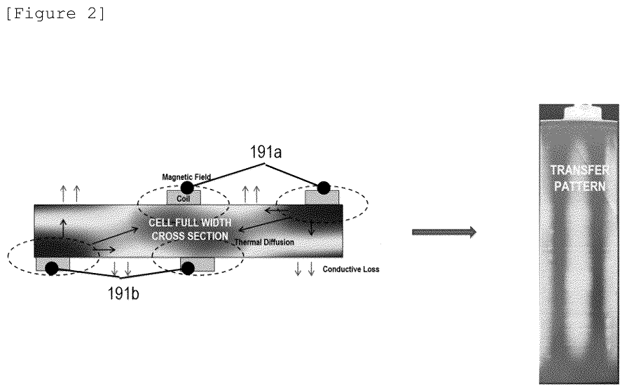

Specifically, in the cell full-width cross-sectional view of FIG. 2, the relatively darker shaded portions extending from the lower left and upper right regions relative to the center indicate a state in which heat spreads from the respective portion in contact with the induction heating coil and the temperature is increased. In the cell full-width cross-sectional view of FIG. 2, the relatively darker shaded portions at the upper left and lower right regions represent areas where the temperature drops due to lack of heat. It could be confirmed that the heat transferred to the induction heating coil exhibits a large difference, depending on locations, and a specific type of transfer pattern appears.

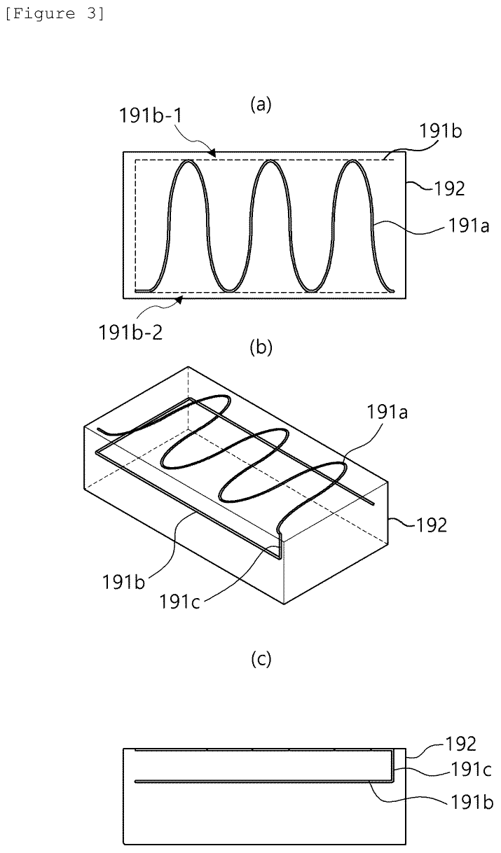

FIGS. 3 and 4 show an induction heating device 190 according to an exemplary embodiment of the present invention. FIG. 3 illustratively shows a form in which the first part of the induction heating coil and the second part of the induction heating coil have a two-layer structure, and FIG. 4 illustratively shows a form in which the first part of the induction heating coil and the second part of the induction heating coil are generally arranged on the same plane.

Part (a) of FIG. 3 shows a form of an induction heating coil that appears when the induction heating plate 192 is seen in a plan or top view. Part (b) of FIG. 3 is a perspective view showing that the induction heating coil is built in the induction heating plate 192. Part (c) of FIG. 3 shows a form of the induction heating coil that appears when the induction heating plate 192 is seen in a cross-sectional view.

Referring to part (a) of FIG. 3 shows the first segment 191b-1 and the second segment 191b-2. As described above, the first segment 191b-1 and the second segment 191b-2 each extend in the first direction along respective first and second sides of the first part of the induction heating coil 191a, the first and second sides opposite each other in the second direction of the induction heating plate 192. It is equally applicable to part (b) of FIG. 3, part (a) of FIG. 4 or part (b) of FIG. 4.

Referring to part (b) of FIG. 3, the induction heating coil may be composed of three parts. The induction heating coil 191 may include a first part 191a of the induction heating coil reciprocating in a zigzag or wave-like shape in the width direction of the induction heating plate 192, a second part 191b of the induction heating coil crossing the first part 191a of the induction heating coil, and a third part 191c of the induction heating coil connecting the first part 191a of the induction heating coil and the second part 191b of the induction heating coil to each other.

Assuming that the first part 191a of the induction heating coil is arranged on a first plane, the second part 191b of the induction heating coil may be arranged on a plane different from the first plane. This is to prevent a short circuit when the second part 191b of the induction heating coil crosses the first part 191a of the induction heating coil.

Therefore, the third part 191c of the induction heating coil may proceed in the depth direction, i.e., in the z-axis direction of the induction heating plate in order to connect the first part 191a of the induction heating coil and the second part 191b of the induction heating coil therebetween.

In other words, the induction heating coil 191 may have a two-layer structure, and may be integrally formed while the third part 191c of the induction heating coil that connects the two layers.

Referring to part (b) of FIG. 3, assuming that the first part 191a of the induction heating coil is arranged on an upper layer (second layer) and the second part 191b of the induction heating coil is arranged on a lower layer (first layer), the second part 191b of the induction heating coil may surround an edge of the first part 191a of the induction heating coil, in the lower layer.

That is, when seen in a plan or top view, the second part 191b of the induction heating coil crosses the first part 191a of the induction heating coil in order to overlap vertices of the serpentine pattern of the semi-elliptical shape made by the first part 191a of the induction heating coil.

As shown in part (b) of FIG. 3, the second part 191b of the induction heating coil winds one turn around the first part 191a of the induction heating coil in order not only to cross the first part 191a of the induction heating coil along a left side of the induction heating plate, but also to cross the first part 191a of the induction heating coil along a right side of the induction heating plate. That is, when seen in a plan view, the second part of the induction heating may have a shape surrounding or overlapping edges of the first part of the induction heating coil.

As a result, referring to the plan view in part (a) of FIG. 3, the first part 191a of the induction heating coil having the serpentine pattern and the second part 191b of the induction heating coil having the linear shape are combined to create multiple closed curves. The plurality of closed curves are arranged to be adjacent to each other in the longitudinal direction of the induction heating plate.

Each of the closed curves can constitute one induction heating unit.

It is further contemplated that the first part 191a and the second part 191b may be shaped in ways other than what is shown in FIGS. 3(a) and 3(b). For example, the first part may form a zigzag formation such that each vertex changes direction more abruptly and defines a sharper corner. In another example, the first part may include a first reciprocating wave on one side of the central axis spanning half the width and the full length of the heating plate 192 and a second reciprocating wave on a second side of the central axis spanning the other half of the width and the full length of the heating plate, such an arrangement increasing the surface area of the heating plate covered by the heating coil. It is also contemplated that the shape of the first part may be modified so as to increase or decrease the size of each induction heating unit. In some examples, the second part may be modified such that the portions extending in the longitudinal direction of the heating plate are positioned more closely to the central axis, or may include a greater number of parallel portions extending in the longitudinal direction, such as four total portions, so that the second part extends from a first end of the heating plate to a second end of the heating plate and back to the first end of the heating plate two times.

As a result, in the induction heating device according to an embodiment of the present invention, a plurality of induction heating units in the form of closed curves densely and adjacently arranged in the induction heating plate are arranged in the longitudinal direction of the induction heating plate, so that heating targets of various sizes can be heated regardless of lengths, as long as widths of the heating targets to be inductively heated are constant.

On the other hand, referring to FIG. 4, unlike the exemplary embodiment of FIG. 3, the first part 191a of the induction heating coil and the second part 191b of the induction heating coil may be arranged on the same plane. It is contemplated that the two parts may be short-circuited with each other when the second part 191b of the induction heating coil crosses the first part 191a of the induction heating coil. Therefore, the second part 191b of the induction heating coil may be designed to avoid or circumvent the first part 191a of the induction heating coil at a place where the second part would otherwise meet the first part 191a of the induction heating coil while crossing the first part 191a of the induction heating coil. In other words, when viewing the plan or top view shown in part (a) of FIG. 4, at each portion where the first part 191a intersects the second part 191b in this view, the second part is shaped to extend in the third dimension to exit the plane on which the first and second parts are generally arranged, and thereafter return to the plane after passing the first part in a separate plane.

As a result, as in the case of FIG. 3, referring to the plan view of part (a) of FIG. 4, the first part 191a of the induction heating coil having the serpentine pattern and the second part 191b of the induction heating coil having the linear shape are combined to create multiple closed curves. The plurality of closed curves are arranged to be adjacent to each other in the longitudinal direction of the induction heating plate.

Each of the closed curves can constitute one induction heating unit.

When seen in a plan view while describing with reference to FIGS. 3 and 4, it should be understood that the design it not limited to the second part 191b of the induction heating coil overlapping the first part 191a of the induction heating coil when crossing the first part. For example, the second part 191b of the induction heating coil may also surround the first part 191a of the induction heating coil at a predetermined distance outward from the edges of the first part 191a of the induction heating coil. It is further contemplated that the first part 191a and the second part 191b may be shaped in ways other than what is shown in FIGS. 4(a) and 4(b). For example, the first part may form a zigzag formation such that each vertex changes direction more abruptly and defines a sharper corner. In another example, the first part may include a first reciprocating wave on one side of the central axis spanning half the width and the full length of the heating plate 192 and a second reciprocating wave on a second side of the central axis spanning the other half of the width and the full length of the heating plate, such an arrangement increasing the surface area of the heating plate covered by the heating coil. It is also contemplated that the shape of the first part may be modified so as to increase or decrease the size of each induction heating unit. In some examples, the second part may be modified such that the portions extending in the longitudinal direction of the heating plate are positioned more closely to the central axis, or may include a greater number of parallel portions extending in the longitudinal direction such as four total portions so that the second part extends from a first end of the heating plate to a second end of the heating plate and back to the first end of the heating plate two times, still circumventing the first part at each point of intersection.

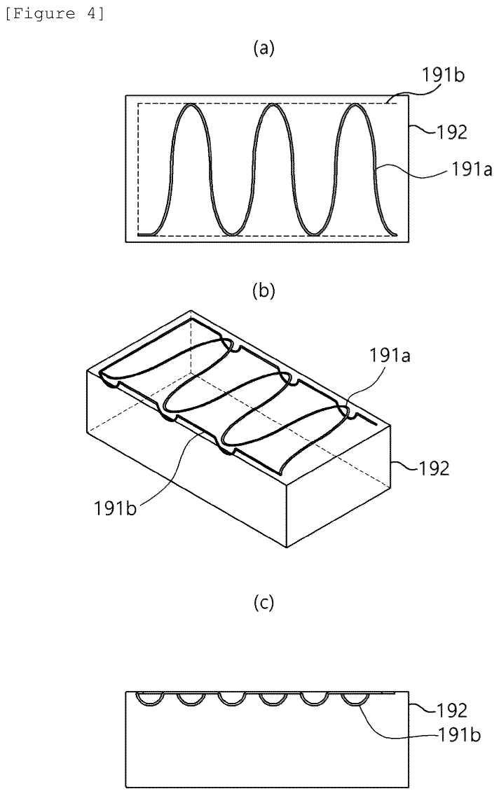

As a result, it could be confirmed as shown in FIG. 5 that the stack can be uniformly heated as a result of induction heating using the induction heating device according to the present invention. That is, as can be seen in FIG. 5, as a result of observing the completed electrode assembly and measuring the adhesive force pattern, it could be confirmed that the adhesive force pattern was uniform.

### <Method for Manufacturing Electrode Assembly>

An exemplary embodiment of the present invention provides a method for manufacturing an electrode assembly including a first electrode, a separator, and a second electrode by using the induction heating device according to an exemplary embodiment of the present invention.

The method for manufacturing an electrode assembly according to an embodiment of the present invention includes a step of inductively heating the stack between a stacking process, which includes the steps of assembling the stack, and a heating and pressing step, which is a step of applying heat and pressure to the stack to bond the component electrodes and separator to each other.

The heating and pressing step involves a lower plate on which an electrode assembly to be heated and pressed is placed and to which heat may be applied, and an upper plate associated with and positioned above the lower plate and to which heat may be applied. The lower plate and the upper plate may be pressing blocks configured as a pair.

In the heating and pressing step of heating and pressing the electrode assembly, electrodes located near the outermost sides of the stack (i.e., the uppermost and lowermost ends of the stack in the stacking direction) are in direct (or close) physical contact with the lower plate and the upper plate, and therefore can receive more heat and pressure than an electrode at a middle position of the stack. That is, in the heating and pressing step, the result is that electrodes in the stack may be heated to different temperatures depending on their positions along the stack, which causes the electrodes and the separator to have different adhesive forces between them, depending on their positions within the stack. As a result, there may occur a problem in that the performance of the electrode assembly becomes non-uniform depending on position along the stack.

Accordingly, in the method for manufacturing an electrode assembly according to an embodiment of the present invention, more heat can be applied to a local region, particularly a central portion along the stacking direction, via the induction heating step. The heat applied to that local region may then diffuse throughout the electrode assembly. By heating and pressing the electrode assembly in the heating and pressing step in conjunction with (i.e., before, after, or concurrently) the induction heating step, the electrode assembly may desirably be more uniformly heated along the stacking direction.

As a result of the increased uniformity in heating, any deviation in air permeability of the separator, as well as any deviation in adhesive force between the separator and the electrodes, at different locations within the stack may be, such that an electrode assembly with more uniform performance can be manufactured.

In an exemplary embodiment of the present invention, the stacking step may include supplying the first electrode to a stack table; supplying the second electrode to the stack table; and supplying the separator to the stack table.

In the present specification, “induction heating” refers to heating a target object by using an electromagnetic induction phenomenon. In this way, Joule heat is generated in the target object by the induced current generated in the target object by the electromagnetic induction phenomenon. Therefore, the induction heating is a heating method capable of locally heating a target object at a certain distance from a heating element. In contrast, a direct heating method involves heating a target object in direct (or close) contact with the target object (e.g., via some combination of conduction, radiation, and/or convection).

A coil may be used to perform the induction heating, which may be defined as an “induction heating coil”. The induction heating method has an advantage in that it is easy to control heat and time applied to a heating target. In addition, the induction heating method is capable of evenly-applied, non-contact heating, and therefore may not damage the heating target.

In the present specification, “induction heating step” may mean locally heating the stack by using an electromagnetic induction heating phenomenon. The locally heated stack may have electrodes arranged in the central portion of the stack. When the direct heating method is used, the uppermost or lowermost electrode(s) of the electrode assembly, which are closer to the applied heat, may be heated more than the central electrode of the electrode assembly. However, in a method for manufacturing an electrode assembly according to an exemplary embodiment of the present invention, the central portion of the electrode assembly is first selectively heated via an induction heating method, and then the electrode assembly may be heated by a direct heating method in a subsequent heating and pressing step, such that the electrode assembly may ultimately be heated more uniformly.

In an exemplary embodiment of the present invention, in the induction heating step, a portion of the stack is inductively heated, and the heat diffuses to other portions of the stack so as to heat the entire stack.

In an exemplary embodiment of the present invention, in the induction heating step, a first electrode or second electrode arranged in a center of the stack may be inductively heated. In the heating and pressing step, a relatively small amount of heat may be applied to the first electrode or second electrode arranged in the center of the stack, as compared with a first electrode or second electrode arranged at the outermost ends of the stack. However, the heat may be first applied to the first electrode or second electrode arranged in the center of the stack through the induction heating step, and then the heating and pressing step may be subsequently performed, so that heat may be uniformly applied throughout the stack.

In the present specification, the induction heating may include induction heating for the entire surface of the stack, in addition to induction heating for only a partial region (local region) of the surface of the stack. However, even when only a partial region is inductively heated, an object of the present invention can be achieved. In addition, the induction heating can be distinguished from the heating and pressing in that no pressure may be applied to the stack during induction heating.

In an exemplary embodiment of the present invention, the induction heating step may be performed for 1 second to 60 seconds, preferably 5 seconds to 40 seconds, and more preferably 10 seconds to 30 seconds. The induction heating time may be selected, considering a degree to which the electrode assembly is non-uniformly heated in the heating and pressing step.

In an exemplary embodiment of the present invention, the induction heating step may inductively heat the stack using an induction heating coil.

The method for manufacturing an electrode assembly according to an exemplary embodiment of the present invention may include a step of conveying the stack to the heating and pressing step after the stacking step. In the conveying step, the stack may be gripped with a gripper.

It is important to stabilize the stack so that the component electrodes and separator do not slide laterally with respect to each other before or during the heating and pressing that results in the electrodes and separators being bonded to each other. Thus, to provide that stability, the gripper may hold the stack by maintaining a grip on the stack during at least part of the heating and pressing step.

The method for manufacturing an electrode assembly according to an exemplary embodiment of the present invention may include inductively heating the stack while conveying the stack from the stack table to the heating and pressing unit. More specifically, in an exemplary embodiment of the present invention, the induction heating step may further include gripping the stack with a gripper including an induction heating coil and conveying the stack between the stacking step and the heating and pressing step. The induction heating step may be performed with the gripper during the conveying step.

More specifically, in an exemplary embodiment of the present invention, the induction heating step may include gripping the stack with a gripper including an induction heating coil; conveying the gripped stack to the heating and pressing step; and inductively heating the stack with the induction heating coil of the gripper while conveying the stack.

With the induction heating coil being built into or attached to the gripper, there is no need to provide a separate space for induction heating, thus making an electrode assembly manufacturing apparatus compact.

Meanwhile, in an exemplary embodiment of the present invention, the induction heating step may further include conveying the stack to an induction heating device including an induction heating coil between the stacking step and the heating and pressing step, and the induction heating step may be performed in the induction heating device. As long as the induction heating device can perform induction heating, any method commonly used in related fields may be used.

More specifically, in an exemplary embodiment of the present invention, the induction heating step may include gripping the stack with a gripper and conveying the gripped stack to an induction heating device including an induction heating coil; and inductively heating the stack in the induction heating device.

The induction heating coil may not be mounted inside or outside the gripper, but rather an induction heating device separate from the gripper may include the induction heating coil. When a separate induction heating device is used, the induction heating step can be performed even when a thickness of the stack including the electrodes and the separator becomes thick.

In addition, when the separate induction heating device is used as in the present embodiment, an electrode tab portion protruding from the electrode may be additionally heated by the induction heating device, and therefore, a temperature difference between the electrode tab and the electrode can be reduced.

In an exemplary embodiment of the present invention, in the induction heating step, the stack may be heated to a temperature between about 40° C. and about 90° C., and preferably between about 50° C. and about 80° C., and even more preferably between about 60° C. or higher and 80° C. or lower. It is believed that, ideally, the stack will be heated to a temperature of about 80° C., but that, during subsequent cooling (after the induction heating has stopped being applied), the temperature of the stack will not drop below about 60° C. before the pressing is applied to the stack in the later heating and pressing step. When the stack is inductively heated within the temperature range described above, the stack can be desirably heated without damaging the electrodes and the separator inside the stack.

In an exemplary embodiment of the present invention, the induction heating coil may be in contact with the stack or spaced from the stack by a predetermined distance.

When the induction heating coil is in contact with the stack (e.g., a distance between the stack and the induction heating coil is 0 mm), the induction heating coil can transfer heat as much as possible, and therefore, it is possible to increase the internal temperature of the stack even if induction heating is performed for a short time.

In addition, when the induction heating coil is spaced from the stack by a predetermined distance, it is possible to increase the internal temperature of the stack without damaging the stack by heat generated from the induction heating coil.

In an exemplary embodiment of the present invention, the predetermined distance may be 15 mm or less. More specifically, in an exemplary embodiment of the present invention, the predetermined distance may be greater than 0 mm and equal to or less than 15 mm, preferably equal to or greater than 0.05 mm and equal to or less than 10 mm, and more preferably equal to or greater than 0.3 mm and equal to or less than 5 mm. When the above distance is satisfied, it is possible to inductively heat the electrode without damaging the stack, as described above.

The method for manufacturing an electrode assembly according to an exemplary embodiment of the present invention may further include, before the heating and pressing step, a step of removing the induction heating unit from a line along which the electrode assembly is being conveyed. In this manner, physical collision between the induction heating unit and the heating and pressing unit can be prevented.

In addition, physical collision between the gripper and the heating and pressing unit can also be prevented by performing a first heating and pressing step and a second heating and pressing step, described later.

The method for manufacturing an electrode assembly according to an exemplary embodiment of the present invention may further include a standby step of allowing the stack to stand by in an atmospheric state for a certain period of time between the induction heating step and the heating and pressing step. The atmospheric state means that after the induction heating step, induction heating is stopped for a certain period of time to wait for heat applied to the stack by the induction heating to diffuse throughout the stack.

Through the standby step, heat transferred to a partial region of the stack may be transferred to the entire region of the stack. In this way, by intentionally stopping the induction heating of the stack for a certain period of time before proceeding with the heating and pressing step, the heat transferred to the stack by the induction heating may diffuse uniformly throughout the stack.

Thereafter, by heating and pressing the stack through the subsequent heating and pressing step, uniformity in thickness of the electrode can be increased throughout the electrode assembly.

In an exemplary embodiment of the present invention, the standby step may be performed for 3 seconds or longer and 60 seconds or shorter, preferably 5 seconds or longer and 45 seconds or shorter, and more preferably 10 seconds or longer and 40 seconds or shorter.

When the time range described above is satisfied, it is possible to provide a time during which heat transferred to a partial region of the electrodes inside the stack by the induction heating can distribute evenly throughout the stack. That is, if the standby step is performed for less than 3 seconds, the heat transferred to a partial region of the stack may be difficult to transfer throughout the electrode. On the other hand, if the standby step is performed for longer than 60 seconds, the temperature of the electrode raised by the transferred heat may be decreased, and therefore, there may be a problem in that the effect of induction heating is reduced.

The standby time may be changed according to the heating time and heating temperature range of the stack in the subsequent heating and pressing step.

In an exemplary embodiment of the present invention, for the step of manufacturing a stack in which the first electrode and the second electrode are alternately arranged between folds of the folded separator, any technology that is commonly used in a related field may be used. For example, processes of stacking a first electrode on the stack table, covering the first electrode with a separator, stacking a second electrode on an upper surface of the separator, folding the separator to cover the second electrode, and stacking a first electrode on the upper surface of the separator may be repeated. This is referred to as a zigzag stacking method in the present exemplary embodiment. In this case, for the process of moving the separator while covering the first electrode or the second electrode placed on the separator, a method in which the stack table moves left and right, a method in which the separator moves left and right, a method in which the stack table rotates, and the like may be applied.

In the zigzag stacking method, a holding mechanism may grip the stack to maintain alignment of the stack during the process of stacking the first electrode, the second electrode, and the separator.

In the present specification, the “holding mechanism” is a tool for gripping a stack placed on a stack table in order to stack the first electrode or the second electrode in the zigzag stacking method, and is different from the gripper for gripping the stack in the heating and pressing step. Nonetheless, both the holding mechanism and the gripper ensure and maintain the alignment of the electrodes and separator when stacked to form the electrode assembly, which is important for the function of the final product that the elements of the assembly remain aligned in the stack.

In an exemplary embodiment of the present invention, the separator may be supplied in a form of an elongated separator sheet. That is, the separator to be additionally supplied may be supplied in a continuous form. In addition, the “upper surface” may refer to a surface opposite to a surface of the stack table on which a separator or electrode is placed.

The method for manufacturing an electrode assembly according to an exemplary embodiment of the present invention may include a heating and pressing step of heating and pressing the stack inductively heated as described above. In the heating and pressing step, the stack may be heated while being pressed in a direction of the stacking axis. In addition, the heating and pressing step may be performed by a heating and pressing unit described later.

Further, in an exemplary embodiment of the present invention, the heating and pressing step may include moving the stack between a pair of pressing blocks including press heaters; surface-pressing the stack by mutually moving the pair of pressing blocks in the direction of the stacking axis; and heating the stack.

The pair of pressing blocks may include a lower plate and an upper plate facing the lower plate.

Further, in another exemplary embodiment of the present invention, the heating and pressing step may include moving the stack between a pair of pressing blocks; surface-pressing the stack by moving the pair of pressing blocks in the direction of the stacking axis; and heating the stack by a separately provided press heater.

The press heater may be included in the pressing block or may be provided as a separate configuration. The method for manufacturing an electrode assembly according to an exemplary embodiment of the present invention may further include a step of releasing gripping of the gripper before the heating and pressing step. That is, the step of releasing gripping of the gripper may include stopping pressing on the upper surface of the stack by the gripper; and spacing the gripper from the stack.

The step of moving the stack between the pair of pressing blocks including press heaters in the heating and pressing step may include not only a case where only the stack itself is moved but also a case where the stack is moved together with the stack table while the stack is positioned on the stack table. In such case, a target to be heated and pressed by the pair of pressing blocks and the press heaters may refer to the stack and the stack table.

In an exemplary embodiment of the present invention, in the heating and pressing step, the stack may be heated and pressed for 5 seconds to 60 seconds under a temperature condition of 50° C. to 90° C. and a pressure condition of 0.5 Mpa to 6.0 Mpa. More preferably, the stack may be heated and pressed for 5 seconds to 30 seconds under a temperature condition of 65° C. to 90° C. and a pressure condition of 1.0 Mpa to 6.0 Mpa. More preferably, the stack may be heated and pressed for 7 seconds to 25 seconds under a temperature condition of 65° C. to 85° C. and a pressure condition of 3 Mpa to 5.5 Mpa.

When heating and pressing are performed while satisfying the above conditions, the adhesive forces between the first electrode and the separator and between the separator and the second electrode can be improved without damaging the first electrode, the separator, and the second electrode. As a result, the performance of the electrode assembly can be improved.

In an exemplary embodiment of the present invention, the heating and pressing step are not performed while the induction heating step is performed.

In an exemplary embodiment of the present invention, the induction heating step may include measuring a temperature distribution on a surface of the stack; setting an induction heating temperature for the stack according to the measured temperature distribution; and inductively heating the stack based on the set induction heating temperature. That is, by adjusting the induction heating temperature of the stack according to the measured temperature distribution of the upper surface of the stack, it is possible to inductively heat the electrode in an efficient manner without using unnecessary energy.

### <Electrode Assembly Manufacturing Apparatus>

An exemplary embodiment of the present invention provides an apparatus for manufacturing an electrode assembly (where the electrode assembly includes a first electrode, a separator, and a second electrode) by using the induction heating device according to an exemplary embodiment of the present invention.

For reference, a semi-finished product state in which the first electrode, the separator, and the second electrode are repeatedly stacked is referred to as a stack, after which a separator winding process is performed on the semi-finished stack so as to produce a single, unified component classified as an electrode assembly.

The electrode assembly manufacturing apparatus includes an induction heating unit. The induction heating unit of the electrode assembly manufacturing apparatus of the present embodiment performs the induction heating step described above. That is, when the electrode assembly manufacturing apparatus according to the present embodiment is used, the stack including the first electrode, the separator, and the second electrode is uniformly heated in the process of performing the heating and pressing step by the heating and pressing unit, so that uniform adhesive force can be obtained between the respective layers in the stack. In addition, as a result, any deviations in the air permeability and/or thickness of the separator along its length are reduced, so that an electrode assembly with uniform performance can be manufactured while reducing a volume of the electrode assembly. In addition, an electrode assembly with an increased energy density per unit volume can be manufactured.

The electrode assembly manufacturing apparatus according to an embodiment of the present invention may further include a separator supply unit configured to supply the separator to the stack table; a first electrode supply unit configured to supply the first electrode to the stack table; and a second electrode supply unit configured to supply the second electrode to the stack table.

In an exemplary embodiment of the present invention, the induction heating unit may be associated with a gripper that grips the stack in order to convey the stack to the heating and pressing unit. The gripper may include an induction heating coil. As described above, the induction heating coil may be built into the gripper or may be installed outside the gripper. When the gripper serves as an induction heating unit, a process space for installing the induction heating unit can be saved. In addition, a process time can also be shortened because induction heating can be performed while conveying the stack. The gripper may perform a function of gripping the stack while conveying the stack from the stack table to the heating and pressing unit.

In an exemplary embodiment of the present invention, the induction heating unit may be a separate component from the gripper that conveys the stack. That is, the induction heating unit may include an induction heating device including an induction heating coil; and a moving unit configured to move the induction heating device to a surface of the stack. When the moving unit moves the induction heating device to an appropriate distance from the stack, the induction heating device may inductively heat the stack. When the induction heating on the stack is completed, the moving unit may separate the induction heating device from the stack.

In this case, as described above, there is an advantage in that it is easy to apply even if the thickness of the stack is thick, and there is an advantage in that it can be used even when inductively heating the electrode tab.

In the present specification, “unit” means an interface that performs a specific function within the electrode assembly manufacturing apparatus.

The induction heating coil of the electrode assembly manufacturing apparatus according to an exemplary embodiment of the present invention may be in contact with the stack or spaced from the stack by a predetermined distance. In this case, the predetermined distance may be 15 mm or less, more specifically, greater than 0 mm and equal to or less than 15 mm, preferably equal to or greater than 0.05 mm and equal to or less than 10 mm, and more preferably equal to or greater than 0.3 mm and equal to or less than 5 mm.

The advantages that are achieved when the induction heating coil is in contact with the stack and when the induction heating coil is spaced from the stack by a predetermined distance are as described in the method for manufacturing an electrode assembly.

The electrode assembly manufacturing apparatus according to an exemplary embodiment of the present invention may further include a control unit configured to receive measurements of a temperature distribution on a surface of the stack, to set or adjust an induction heating temperature for the stack according to the measured temperature distribution, and to determine whether to stop induction heating for the stack based on the induction heating temperature and an induction heating time for the stack.

In addition, the control unit may also be configured to set or adjust the induction heating time for the stack. That is, a condition for performing the induction heating step and a condition for performing the standby step can be set by the control unit. For each condition, the contents described in the method for manufacturing an electrode assembly may be applied.

In an exemplary embodiment of the present invention, the heating and pressing unit may include a pair of pressing blocks, and may be configured to surface-press the stack while moving the pair of pressing blocks in directions towards one another.

The heating and pressing unit includes a pair of pressing blocks and a press heater for heating the pressing blocks. While the press heater heats the pressing blocks, the pair of pressing blocks move in directions towards one another, so that the stack placed between the pressing blocks can be surface-pressed. For example, the pair of pressing blocks may include press heaters therein.

In another exemplary embodiment of the present invention, the heating and pressing unit may be two separate heating and pressing units. That is, the heating and pressing unit may include a first heating and pressing unit and a second heating and pressing unit.

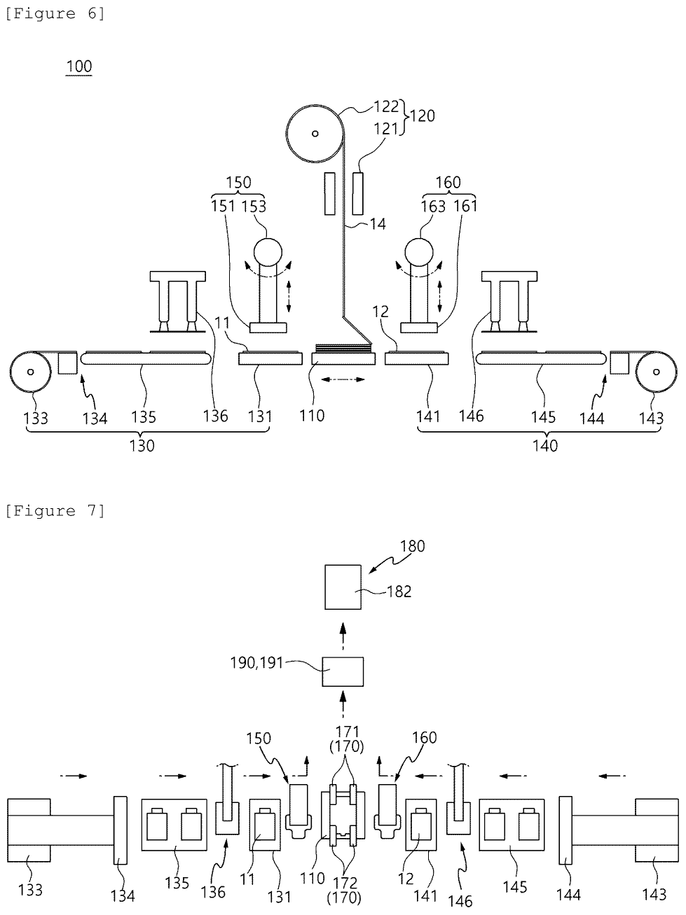

Referring to FIG. 7, the first heating and pressing unit may include a pair of first pressing blocks. Pressing surfaces of the pair of first pressing blocks may include grooves corresponding to the structure of the gripper so as to press the stack while the gripper grips the stack. The pressing surfaces other than the grooves may be planes. The second heating and pressing unit may include a pair of second pressing blocks. Pressing surfaces of the pair of second pressing blocks may be provided as planes. That is, when the stack is placed on the press surfaces of the pressing blocks, the second pressing blocks may move towards one another to heat and press the stack.

When the heating and pressing unit is separated into two units as described above, it is possible to prevent loss of adhesive force between respective layers inside the stack due to cooling while the heated stack is conveyed.

Conditions for heating and pressing the stack by the heating and pressing unit may be the same as those of the heating and pressing step described above.

In an exemplary embodiment of the present invention, the stack table may include a table body on which the stack is placed, and a drive unit configured to drive the table body. The table body may include a stack table heater capable of heating the stack to a predetermined temperature when the stack is placed on the table body.

In an exemplary embodiment of the present invention, the first electrode supply unit may include at least one of a first electrode seating table, a first electrode roll, a first cutter, a first conveyor belt, and a first electrode supply head.

In addition, the first electrode seating table may include a first electrode heater for heating the first electrode placed on the first electrode seating table to a predetermined temperature.

In an exemplary embodiment of the present invention, the second electrode supply unit may include at least one of a second electrode seating table, a second electrode roll, a second cutter, a second conveyor belt, and a second electrode supply head.

In addition, the second electrode seating table may include a second electrode heater for heating the second electrode placed on the second electrode seating table to a predetermined temperature.

In an exemplary embodiment of the present invention, a first electrode stacking unit may include a first suction head that grasps the first electrode seated on the first electrode seating table via vacuum suction. The first electrode may be moved from the first electrode seating table to the stack table by the first electrode stacking unit.

A second electrode stacking unit may include a second suction head that grasps the second electrode seated on the second electrode seating table via vacuum suction. The second electrode may be moved from the second electrode seating table to the stack table by the second electrode stacking unit.

In an exemplary embodiment of the present invention, the first electrode may be a positive electrode, and the second electrode may be a negative electrode.

In another exemplary embodiment of the present invention, the first electrode may be a negative electrode, and the second electrode may be a positive electrode.

In an exemplary embodiment of the present invention, for current collectors used for a positive electrode and a negative electrode, an active material, and a conductive material may be included, and active materials and conductive materials known in the art can be used without limitation. Likewise, for methods for manufacturing the positive electrode and the negative electrode, methods known in the related art can be used without limitation.

In an exemplary embodiment of the present invention, for the separator, separator materials known in the art can be used without limitation, and, likewise, for a method for manufacturing a separator, methods known in the related art can be used without limitation. However, in an exemplary embodiment of the present invention, the separator may include a porous polymer substrate and an organic/inorganic composite porous coating layer formed on at least one surface of the polymer substrate, and the organic/inorganic composite porous coating layer may include particulate binder resins and inorganic particles.

In an exemplary embodiment of the present invention, the particulate binder resin may include at least one selected from the group consisting of a fluorine-based polymer, an acrylic polymer particle, and a hybrid polymer particle of an acrylic polymer particle and an acrylic polymer.

In an exemplary embodiment of the present invention, the fluorine-based polymer may be a homopolymer of vinylidene fluoride, a copolymer of vinylidene fluoride and another polymerizable monomer, or a mixture of two or more thereof.

In an exemplary embodiment of the present invention, the inorganic particle may be Al₂O₃, but is not limited thereto.

Since the organic/inorganic composite porous coating layer is included, an electrode assembly having increased adhesive force between the electrode and the separator can be manufactured by applying the induction heating step and the heating and pressing step described in the electrode assembly manufacturing method and/or the electrode assembly manufacturing apparatus.

Hereinafter, an electrode assembly manufacturing apparatus and an electrode assembly manufacturing method according to an exemplary embodiment of the present invention will be described in more detail. The following description assumes that the electrode assembly of the present invention is zigzag stacked, as depicted in FIG. 8.

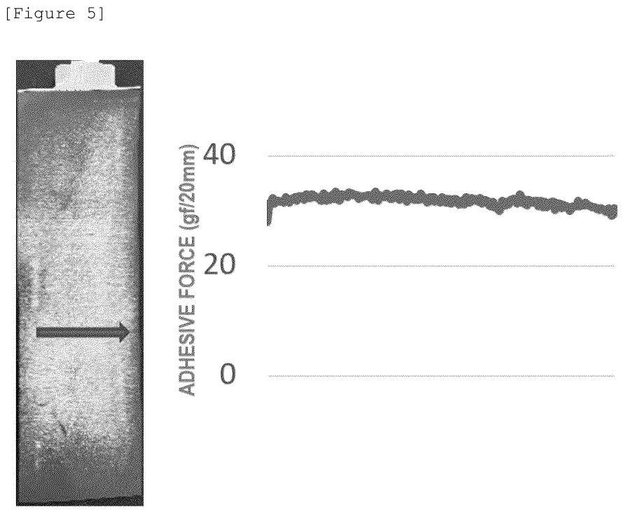

FIG. 6 is a side elevation view schematically illustrating an electrode assembly manufacturing apparatus and its process flow according to an exemplary embodiment of the present invention, and FIG. 7 is a top plan view illustrating the electrode assembly manufacturing apparatus and its process flow according to the exemplary embodiment. For convenience, in FIG. 6, a holding mechanism 170, a heating and pressing unit 180, and an induction heating unit 190 (all shown in FIG. 7) are omitted, and in FIG. 7, a separator supply unit 120 (shown in FIG. 6) is omitted.

Referring to FIGS. 6 to 8, an electrode assembly manufacturing apparatus 100 according to an exemplary embodiment of the present invention includes a separator supply unit 120 that supplies a separator 14 to a stack table 110, a first electrode supply unit 130 that supplies a first electrode 11 to the stack table 110, and a second electrode supply unit 140 that supplies a second electrode 12 to the stack table 110. The separator 14, the first electrode 11, and the second electrode 12 may be each supplied to the stack table 110 while being heated in the separator supply unit 120, the first electrode supply unit 130, and the second electrode supply unit 140, respectively.

The electrode assembly manufacturing apparatus 100 according to an exemplary embodiment of the present invention includes a first electrode stacking unit 150 that stacks the first electrode 11 supplied by the first electrode supply unit 130 on the stack table 110, and a second electrode stacking unit 160 that stacks the second electrode 12 supplied by the second electrode supply unit 140 on the stack table 110. In this case, the separator 14 supplied by the separator supply unit 120 is stacked in a zigzag form while alternately being fed to the left side and the right side of the stacking axis. In this case, any one of the first electrode 11 and the second electrode 12 is alternately inserted into spaces (between a first portion of the separator and a second portion of the separator adjacent the first portion of the separate, wherein the first and second portions are separated by a fold in the separator) generated while the separator 14 is folded. As a result, a stack in which the first electrode 11, the separator 14, the second electrode 12, and the separator 14 are repeatedly stacked is assembled on the stack table 110.

The separator supply unit 120 may include a separator heating unit 121 and a separator roll 122. The separator heating unit 121 may be selectively operated. The first electrode supply unit 130 may include a first electrode seating table 131, a first electrode heater (not shown), a first electrode roll 133, a first cutter 134, a first conveyor belt 135, and a first electrode supply head 136. The first electrode heater 132 may be selectively operated.

The second electrode supply unit 140 may include a second electrode seating table 141, a second electrode heater (not shown), a second electrode roll 143, a second cutter 144, a second conveyor belt 145, and a second electrode supply head 146. The second electrode heater 142 is selectively applicable.

The first electrode stacking unit 150 stacks the first electrode 11 on the stack table 110. In this case, the first electrode stacking unit 150 may include a first suction head 151, a first head heater (not shown), and a first moving unit 153. In addition, the second electrode stacking unit 160 stacks the second electrode 12 on the stack table 110. The second electrode stacking unit 160 may include a second suction head 161, a second head heater (not shown), and a second moving unit 163.

The first electrode stacking unit 150 and the second electrode stacking unit 160 may further include heaters (not shown) for preheating the first electrode and the second electrode according to circumstances.

The electrode assembly manufacturing apparatus 100 according to an exemplary embodiment of the present invention may further include a holding mechanism 170 for securing the first electrode 11 and the second electrode 12 when they are stacked on the stack table 110. Further, the electrode assembly manufacturing apparatus 100 according to an exemplary embodiment of the present invention includes a heating and pressing unit 180 that heats and presses the stack placed on the stack table 110 to bond the first electrode 11, the separator 14, and the second electrode 12 to one another.

The electrode assembly manufacturing apparatus 100 according to an exemplary embodiment of the present invention further includes an induction heating unit 190 that inductively heats the stack to transfer heat to the electrodes in the stack. In addition, a control unit (not shown) for controlling, for example, whether to actuate the induction heating unit 190 may be further included. Through this, it is possible to finally manufacture an electrode assembly 10 as shown in FIG. 8.

FIG. 8 is a cross-sectional side elevation view illustratively showing an electrode assembly manufactured by an electrode assembly manufacturing apparatus and an electrode assembly manufacturing method according to an exemplary embodiment of the present invention.

Referring to FIG. 8, the electrode assembly 10 may have a stacked form including a separator 14 folded and stacked in a zigzag form, along with first electrodes 11 and second electrodes 12 alternately inserted into spaces between folds of the separator. That is, electrode assembly 10 is formed in the manner described in great detail above using the method described above, which includes placing a first electrode on a surface of a separator, folding the separator at a location adjacent an end of the first electrode so that the separator covers the first electrode, placing a second electrode on an available surface of the separator, folding the separator at a location adjacent an end of the second separator so that the separator covers the second electrode, and repeating this process to form the stack shown in FIG. 8. It is noted that each of the electrode in the assembly shown in FIG. 8 are separated by a portion of the separator, and that the stack of electrode alternate between positive and negative electrodes.

In this case, the electrode assembly 10 may also be provided in such a form that the separator 14 surrounds the outermost perimeter of the stack. However, it should be noted that the configuration of the electrode assembly 10 is not limited to the example of FIG. 3.

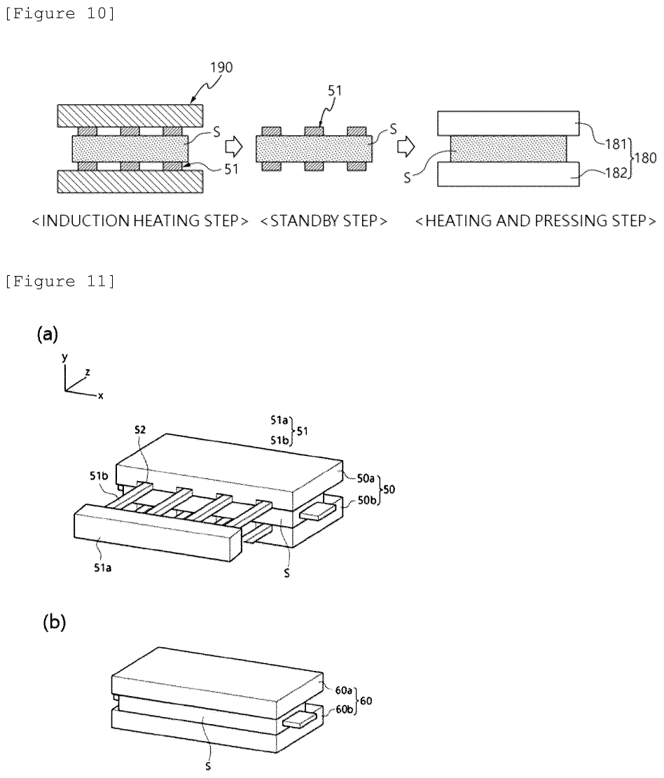

FIGS. 9 and 10 are views schematically showing an operation process of the induction heating unit according to an exemplary embodiment of the present invention.

Specifically, FIG. 9 shows a case where the induction heating unit 190 is part of a gripper 51. The gripper 51 may include an induction heating coil (not shown). The gripper 51 may perform induction heating on the stack S while gripping the stack S. While performing induction heating by the gripper 51, the stack S may be conveyed to the heating and pressing unit 180. In the heating and pressing unit 180, the stack S may be heated and pressed. In this case, before heating and pressing the stack S in the heating and pressing unit 180, a standby process (step) of stopping induction heating on the stack S and causing the stack to stand by for a certain period of time may be performed. In this case, a condition (such as the length of time) of the standby process may be set by a control unit (not shown).

FIG. 10 shows another exemplary embodiment of the induction heating unit, illustrating that the stack S is inductively heated using the induction heating device 190 provided separately from the gripper 51. In this case, the stack S is inductively heated after being moved to the induction heating device. When the induction heating is completed, the stack S may be heated and pressed in the heating and pressing unit 180 as in FIG. 4. In this case, before heating and pressing the stack S in the heating and pressing unit 180, a standby process (step) of stopping induction heating on the inductively heated stack S and causing the stack to stand by for a certain period of time may be performed. In this case, a condition of the standby process may likewise be controlled by the control unit (not shown). As shown in FIG. 5, the standby process may be performed after the stack S is moved out of the induction heating unit 190 and while the stack S is gripped by the gripper 51.

For the induction heating unit 190 of FIGS. 9 and 10, the induction heating device according to an exemplary embodiment of the present invention may be used.

In the present embodiment, the induction heating is performed in advance before the heating and pressing step, targeting electrodes arranged at the central portion of the electrode assembly, which are not particularly well heated in the heating and pressing step.

FIG. 11 shows a configuration of the heating and pressing unit, and particularly shows a case where the heating and pressing unit includes a first heating and pressing unit 50 and a second heating and pressing unit 60.

Part (a) of FIG. 11 is a perspective view showing the first heating and pressing unit 50, and part (b) of FIG. 11 is a perspective view showing the second heating and pressing unit 60.

Referring to part (a) of FIG. 11, the first heating and pressing unit 50 may heat and press the stack S in a state where the stack S is secured by the gripper 51. The first heating and pressing unit 50 may include a pair of first pressing blocks 50a and 50b. In the pair of first pressing blocks 50a and 50b, pressing surfaces for pressing are all planes except for one or more grooves corresponding to the structure of a fixing part 51b of the gripper 51. As shown in part (a) of FIG. 11, the fixing part 51b of the gripper 51 may include two opposed contact parts, each of which may comprise an array of spaced apart contact members defined by, for example, generally parallel rods, columns, or plates spaced apart from one another in the length (x) direction and extending across the stack S in the width (z) direction. The array of the first contact part may be arranged to come into contact with the upper surface of the stack S, and the array of the second contact part may be arranged to come into contact with the lower surface of the stack S.

The gripper 51 may include a main body 51a corresponding to a length (x) and height (y) of the stack S or greater than the length (x) and height (y) of the stack S, and a fixing part 51b that protrudes from the main body 51a and holds the stack S. Here, the length (x) of the stack S means the longest part of the distance from one end to the other end of the stack S, the height (y) means a distance of the stack S in the stacking direction, and the width (z) may mean a distance horizontally crossing an upper surface of the stack S.

The fixing part 51b can be positioned along the height direction of the main body 51a, so that the fixing part 51b can contact upper and lower surfaces of the stack S to securely grip the stack S.

Thereafter, the pair of first pressing blocks 50a and 50b move in directions towards one another to heat and press the stack S. The electrodes and separator inside the electrode assembly become stably bonded through the heating and pressing.

The first heating and pressing unit 50 may be a component that counteracts any cooling in the electrode assembly while the inductively heated electrode assembly moves, and thus the first heating and pressing unit may be optionally provided. That is, the first heating and pressing unit may be omitted in some cases.

Referring to part (b) of FIG. 11, the second heating and pressing unit 60 may finally heat and press the stack S that has been primarily heated and pressed by the first heating and pressing unit 50. The second heating and pressing unit 60 includes a pair of second pressing blocks 60a and 60b, and the pair of pressing blocks 61 and 62 may be moved in directions towards one another to surface-press the stack S. In addition, in the pair of second pressing blocks 60a and 60b included in the second heating and pressing unit 60, pressing surfaces for pressing in contact with the stack S may all be provided as planes.

A benefit of using the first heating and pressing unit 50 prior to the second heating and pressing unit 60 is that the first heating and pressing unit 50 includes the gripper 51 to maintain alignment of the electrode assembly while it is heated and pressed, which accomplishes at least initial bonding of the electrodes and the separator. After said initial bonding, the second heating and pressing unit 60 can be used without the need for a gripper because alignment of the electrode assembly will be maintained by the initial bonding. Thus, the second heating and pressing unit 60 can be implemented with the pair of second pressing blocks 60a and 60b contacting an entirety of the surfaces of the electrode assembly to more effectively heat, press and bond the electrode assembly.

The description of the electrode assembly manufacturing method according to the present invention may also be applied to the electrode assembly manufacturing apparatus according to the present invention, and vice versa.

Although the exemplary embodiments of the present invention have been described in detail, it will be obvious to one skilled in the art that the scope of the present invention is not limited thereto and various modifications and variations can be made without departing from the technical spirit of the present invention defined in the claims.

What is claimed is:

1. An induction heating device comprising:
an induction heating plate; and
an induction heating coil included in the induction heating plate,
wherein the induction heating coil comprises:
a first part of the induction heating coil defining a meandering serpentine pattern that extends along a first direction of the induction heating plate while reciprocating in a second direction of the induction heating plate, the second direction being orthogonal to the first direction, and
a second part of the induction heating coil arranged to cross the first part of the induction heating coil when projected along a third direction orthogonal to both the first and second directions, wherein the second part includes a first segment and a second segment each extending in the first direction along respective first and second sides of the first part of the induction heating coil, the first and second sides being opposed to one another in the second direction of the induction heating plate.

2. The induction heating device of claim 1, wherein the induction heating plate comprises:
a first induction heating plate on which an electrode assembly comprising a positive electrode, a negative electrode, and a separator arranged between the positive electrode and the negative electrode is configured to be placed; and
a second induction heating plate opposed to and facing the first induction heating plate.

3. The induction heating device of claim 1, wherein the first part of the induction heating coil is disposed along a first plane and the second part of the induction heating coil is disposed along a second plane different from the first plane, and the first and second parts are connected to each other by a third part of the induction heating coil.

4. The induction heating device of claim 3, wherein the third part of the induction heating coil extends along the third direction perpendicular to the first and second planes.

5. The induction heating device of claim 1, wherein the first part of the induction heating coil is disposed along a first plane and the second part of the induction heating coil is disposed along the first plane, the second part circumventing the first part so as not to be short-circuited with the first part of the induction heating coil.

6. The induction heating device of claim 1, wherein, when projected along the third direction, the second part of the induction heating coil is arranged to cross vertices defined on the first part of the induction heating coil.

7. The induction heating device of claim 1, wherein the second part of the induction heating coil is configured to surround an outer edge of the first part of the induction heating coil in the second direction when projected along the third direction.

8. The induction heating device of claim 1, wherein the first part of the induction heating coil and the second part of the induction heating coil are arranged to define at least one closed curve when projected along the third direction.

9. The induction heating device of claim 1, wherein the induction heating plate comprises a non-conductive material.

10. The induction heating device of claim 1, wherein the first direction is a longitudinal direction of the induction heating plate while the second direction is a width direction of the induction heating plate.

11. The induction heating device of claim 1, wherein the first part of the induction heating coil is configured to form a semi-elliptical shape while reciprocating in the second direction of the induction heating plate,
wherein the semi-elliptical shape has a long radius in the second direction of the induction heating plate and a short radius in the first direction of the induction heating plate,
wherein the long radius is between 50 mm and 80 mm, and
wherein the short radius is between 10 mm and 40 mm.

12. The induction heating device of claim 11, wherein first part of the induction heating coil includes a plurality of the semi-elliptical shape arranged periodically along the first direction of the induction heating plate.

13. The induction heating device of claim 12, wherein the period is between 10 mm and 30 mm.

14. The induction heating device of claim 1, wherein the second part of the induction heating coil includes a third segment extending transverse to the first and second segments at a terminal end of the second part.

15. A method for manufacturing an electrode assembly comprising a first electrode, a separator, and a second electrode, the method comprising:
stacking a stack comprising the first electrode, the separator, and the second electrode on a stack table;
inductively heating the stack; and
heating and pressing the inductively heated stack.

16. The method of claim 15, wherein the stack is inductively heated with an induction heating plate including an induction heating coil, wherein the induction heating coil comprises:
a first part of the induction heating coil defining a meandering serpentine pattern that extends along a first direction of the induction heating plate.

17. The method of claim 16, wherein the induction heating coil further comprises:
a second part of the induction heating coil arranged to cross the first part of the induction heating coil when projected along a third direction orthogonal to both the first and second directions, wherein the second part includes a first segment and a second segment each extending in the first direction along respective first and second sides of the first part of the induction heating coil, the first and second sides being opposed to one another in the second direction of the induction heating plate.

18. An electrode assembly manufacturing apparatus for manufacturing an electrode assembly comprising a first electrode, a separator, and a second electrode, the electrode assembly manufacturing apparatus comprising:
a stack table on which a stack including the first electrode, the separator, and the second electrode is configured to be placed;
a heating and pressing unit configured to heat and press the stack; and
the induction heating device of claim 1 configured to inductively heat the stack before heating and pressing the stack in the heating and pressing unit.

19. An induction heating device comprising:
an induction heating plate; and
an induction heating coil included in the induction heating plate,
wherein the induction heating coil comprises:
a first part of the induction heating coil extending along a first direction while reciprocating in a second direction orthogonal to the first direction, and
a second part of the induction heating coil arranged to cross a vertex defined by the first part of the induction heating coil when projected along a third direction orthogonal to both the first and second directions.

20. The induction heating device of claim 19, wherein the second part of the induction heating coil includes a segment extending tangential to the vertex defined by the first part of the induction heating coil when projected along the third direction.
